(19) United States
(12) Patent Application Publication
(10) Pub. No.: US 2009/0133557 A1
(43) Pub. Date: May 28, 2009

(54) SHEET POSITIONING DEVICE FOR TABLE SAW

(75) Inventor: Landon Worthington, Moorpark, CA (US)

Correspondence Address: KELLY LOWRY & KELLEY, LLP, 6320 CANOGA AVENUE, SUITE 1650, WOODLAND HILLS, CA, 91367, US

(73) Assignee: LANDON INNOVATIONS, LLC, Moorpark, CA (US)

(21) Appl. No.: 12/323,136

(22) Filed: Nov. 25, 2008

Related U.S. Application Data
(60) Provisional application No. 60/990,843, filed on Nov. 28, 2007.

(51) Int. Cl. B26D 7/02; B26D 1/14

(52) U.S. Cl. 83/452; 83/477.2

(57) ABSTRACT

A device for lifting and positioning a sheet of material onto a table saw includes a clamp portion for attachment to the table saw. An elongated arm is pivotally attached to the clamp portion, and has a catch adapted to receive an edge of a vertically oriented sheet. The arm and sheet are lifted upwardly, so that the sheet is placed in a generally horizontal position on the table saw.

### BACKGROUND OF THE INVENTION

The present invention generally relates to table saws. More particularly, the present invention relates to a sheet positioning device attachable to the table saw for lifting and positioning sheets of material to be cut by the table saw.

A table saw is probably the most common piece of large woodworking equipment. Because of its versatility, when only one piece of large woodworking machinery is owned, it will often be a table saw. The table saw typically consists of a circular saw blade, mounted on an arbor, that is driven by an electric motor. The blade protrudes through the surface of a table, which provides support for the material, usually wood, being cut. Typically, the blade can be moved up and down, so as to vary the depth of the cut. Also, the angle of the cut is controlled by adjusting the angle of the blade. Many table saws also include a fence, sometimes referred to as a guide or rip fence, running from the front of the table nearest the operator, to the back parallel to the cutting plane of the blade. The distance of the fence from the blade can be adjusted, which determines where on the work piece the cut is made.

A problem arises when the operator is cutting a large piece of material. Such large pieces of material are often large sheets of plywood and the like. These sheets of material can be several feet in length and width, and due to their size and weight are awkward to lift and position onto the table. Moreover, this can present a safety issue for a single operator trying to lift the large sheet of material onto the table saw. This is due to the fact that the table saw must typically be turned on so that the motor and blade are running prior to lifting the sheet of material onto the table saw. Otherwise, the sheet of material is left precariously hanging on the table saw as the operator attempts to power on the table saw.

Accordingly, there is a need for a device which assists in positioning and lifting such sheets of material to be cut onto the table saw. The present invention fulfills these needs, and provides other related advantages.

### SUMMARY OF THE INVENTION

The present invention is directed to a sheet positioning device, which is attachable to a table saw for lifting and positioning sheets of material to be cut by the table saw.

The device comprises a clamp which is attachable to the table saw. Typically, the clamp comprises a generally U-shaped member having a bolt extendable therein. The clamp is adapted to be inserted over and affixed to either an edge of the table of the table saw, or a wall of a fence of the table saw.

An arm is pivotally attached to the clamp, at one end thereof. A catch extends from the arm, typically at a generally opposite end of the arm as the clamp, and is configured to receive an edge of the sheet therein. The catch comprises a platform extending from the arm generally transverse to a longitudinal axis of the arm. A projection extends from the platform in spaced relation and generally parallel to the arm to form an open-faced channel.

In a particularly preferred embodiment, a damper device is interconnected between the arm and the clamp. The damper device is adapted to dampen movement, and particularly downward movement, of the arm. The damper device comprises a bar pivotally attached to the clamp, including an elongated slot therein. A resistive member extends from the arm and into the slot. The resistive member comprises a bolt extending through the slot, with at least one washer in frictional engagement with the bar.

In use, an edge of the sheet is disposed on the platform of the catch and the arm is pivoted upwardly, typically by rotating the sheet, until the sheet is moved from a generally vertical orientation to a generally horizontal orientation and onto a top table surface of the table saw.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective diagrammatic view of the sheet positioning device of the present invention attached to a table saw and having a sheet of material supported thereon;

FIG. 2 is a diagrammatic perspective view similar to FIG. 1, but illustrating the sheet of material and an arm of the device swung upwardly into a generally horizontal position;

FIG. 3 is a diagrammatic view similar to FIG. 2, but illustrating the sheet of material being moved onto a table of the table saw, in accordance with the present invention;

FIG. 4 is a diagrammatic view similar to FIGS. 1-3, and illustrating the release of the device, and the cutting of the sheet of material by the table saw;

FIG. 5 is a front perspective view of the sheet positioning device of the present invention, in a relaxed state, wherein an arm thereof is positioned generally vertically;

FIG. 6 is a fragmented and enlarged perspective view of a clamp of the device of the present invention being aligned with a wall of a fence of the table saw, in accordance with the present invention;

FIG. 7 is a enlarged and fragmented perspective view similar to FIG. 6, but illustrating the clamp affixed to the fence;

FIG. 8 is a front perspective view of the device of the present invention, illustrating the arm moved into a generally horizontal position;

FIG. 9 is a diagrammatic perspective view of the device of the present invention, illustrating the arm moved between generally vertical and horizontal positions;

FIG. 10 is a front perspective view of another sheet positioning device embodying the present invention;

FIG. 11 is a enlarged and partially fragmented perspective view illustrating a clamp of the device aligned with an edge of the table saw;

FIG. 12 is a enlarged perspective view similar to FIG. 11, illustrating the clamp and device affixed to the table saw;

FIG. 13 is a front perspective view of the device, illustrating an arm thereof moved into a generally horizontal position; and

FIG. 14 is a perspective and diagrammatic view illustrating an arm of the device moved between generally vertical and horizontal positions, in accordance with the present invention.

### DETAILED DESCRIPTION OF THE PREFERRED EMBODIMENTS

As shown in the accompanying drawings, for purposes of illustration, the present invention is directed to a sheet positioning device, generally referred to by the reference number 100, for positioning a sheet of material 10 onto a table saw 20. As more fully explained herein, the device 100 is attachable to the table saw 20, and permits a single user to conveniently and easily lift and position a sheet of material, such as a sheet of plywood or the like, onto the table saw 10 for cutting.

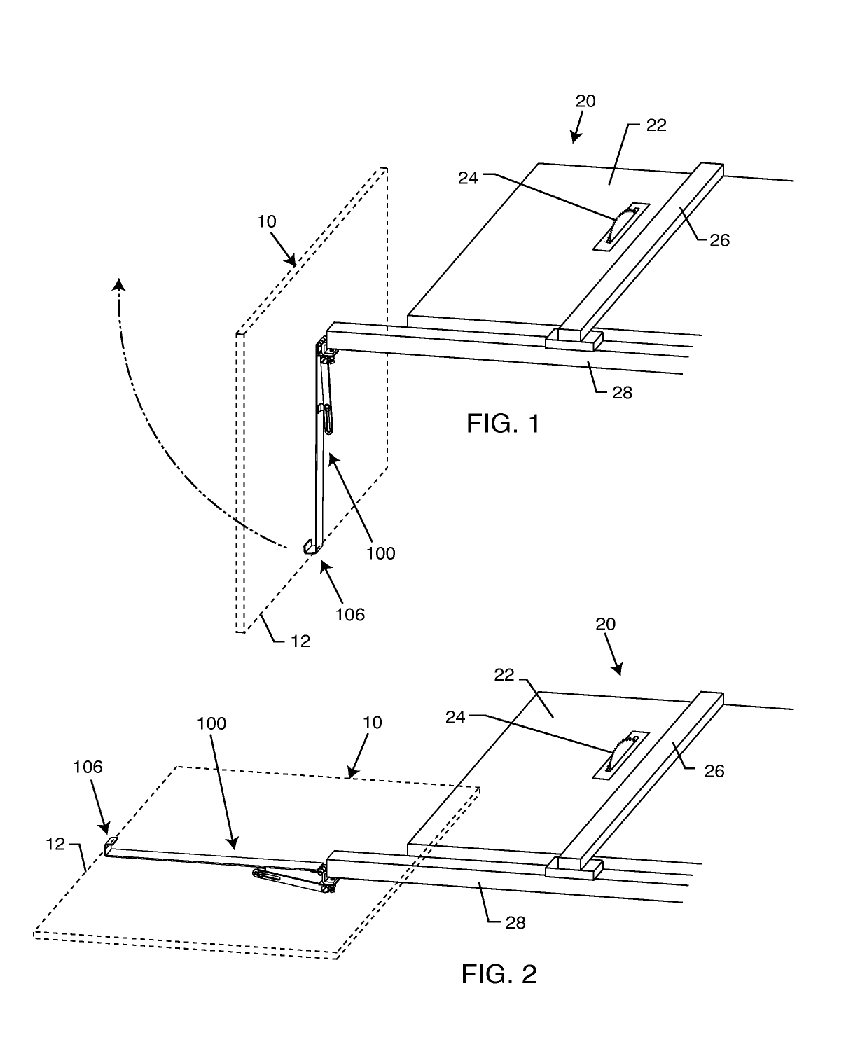

With reference now to FIGS. 1-4, table saws are well known in the art and include a generally planar top surface, constituting a table 22 having a rotating cutting blade 24 extending upwardly through an aperture thereof. Some table saws 20 are equipped with a fence, comprising a fence guide 26 which runs generally parallel to the blade 24, and rests on or slightly above the table 22 of the table saw 20. The fence also includes a rail 28 that is positioned at the front edge of the table 22, as illustrated. The fence guide 26 may slidingly move along the length of the front fence rail 28, or the fence guide 26 and rail 28 may move to the left and to the right together, being slidably attached to another rail or guide (not shown). The table saw 20 also includes electrical connections, a motor, etc. for selectively powering and rotating the cutting blade 24, as is well known in the art, which are typically housed in a base of the table saw 20, and are not shown for purposes of illustration.

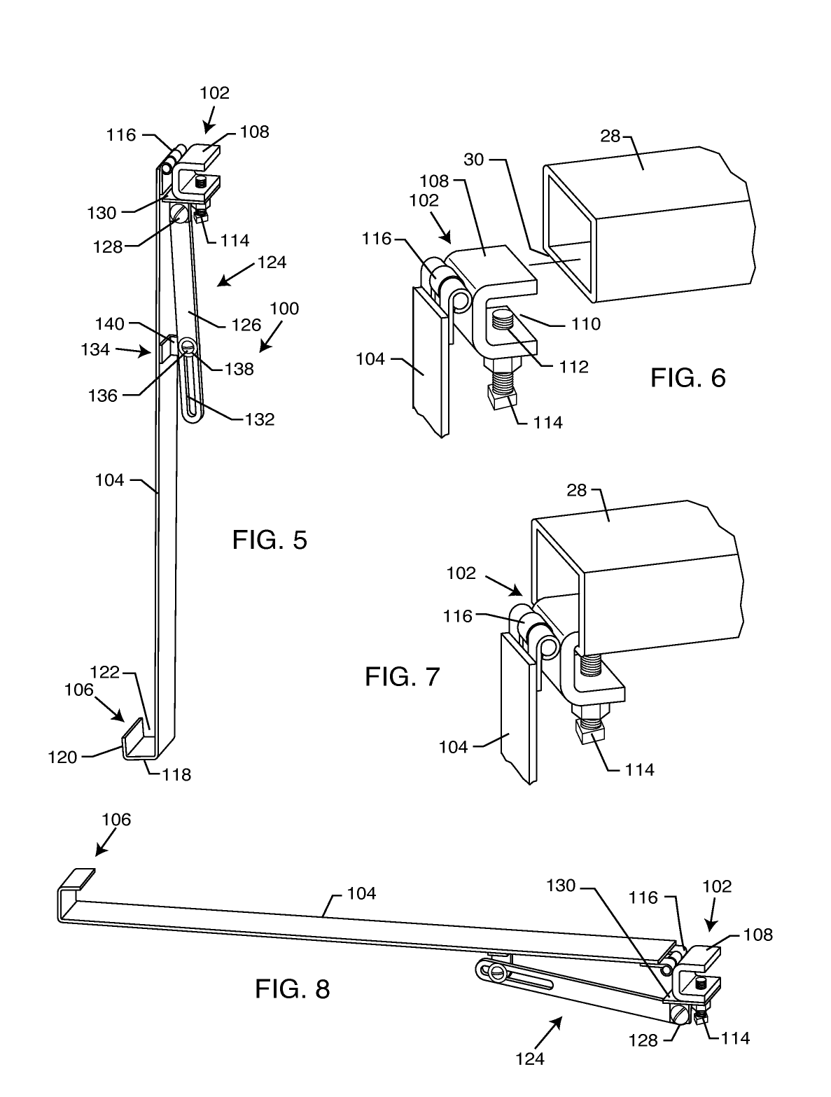

With reference now to FIG. 5, the device 100 of the present invention includes a clamp 102 which is attachable to the table saw 20, an arm 104 pivotally attached to the clamp 102, and a catch 106, typically at an end of the arm 104 generally opposite the clamp 102, configured to receive and support an edge of a sheet of material 10 thereon.

With reference now to FIGS. 6 and 7, the clamp 102 comprises a generally U-shaped member 108 which is sized and configured so as to be attachable to an edge of the table 22 of the table saw or a wall of the fence 28 of the table saw 20. The U-shaped member defines an open-faced channel 110 adapted to receive an exposed edge 30 of a wall of the fence 28, as illustrated in FIG. 6. An aperture 112 is formed through at least one portion or wall of the U-shaped member 108, for insertion of a bolt 114 or set screw or the like. Preferably, the aperture 112 has interior threads so as to engage the exterior threads 114 of the bolt. In this manner, as illustrated in FIGS. 6 and 7, the U-shaped member 108 can be slid over the exposed edge 30 of the fence 28 and the bolt or set screw 114 tightened so as to securely affix the clamp 102, and thus the device 100 to the exposed edge of the fence 28. As illustrated in FIGS. 1-4, such placement will typically be at the side edge of the table saw 20, such that the arm 104 of the device 100 hangs vertically downwardly therefrom. It will be appreciated by those skilled in the art that in some cases an end cap is positioned at the far end of the guide rail 28. However, such end caps can typically be removed, enabling the attachment of the clamp 102, and device 100, to the fence 28.

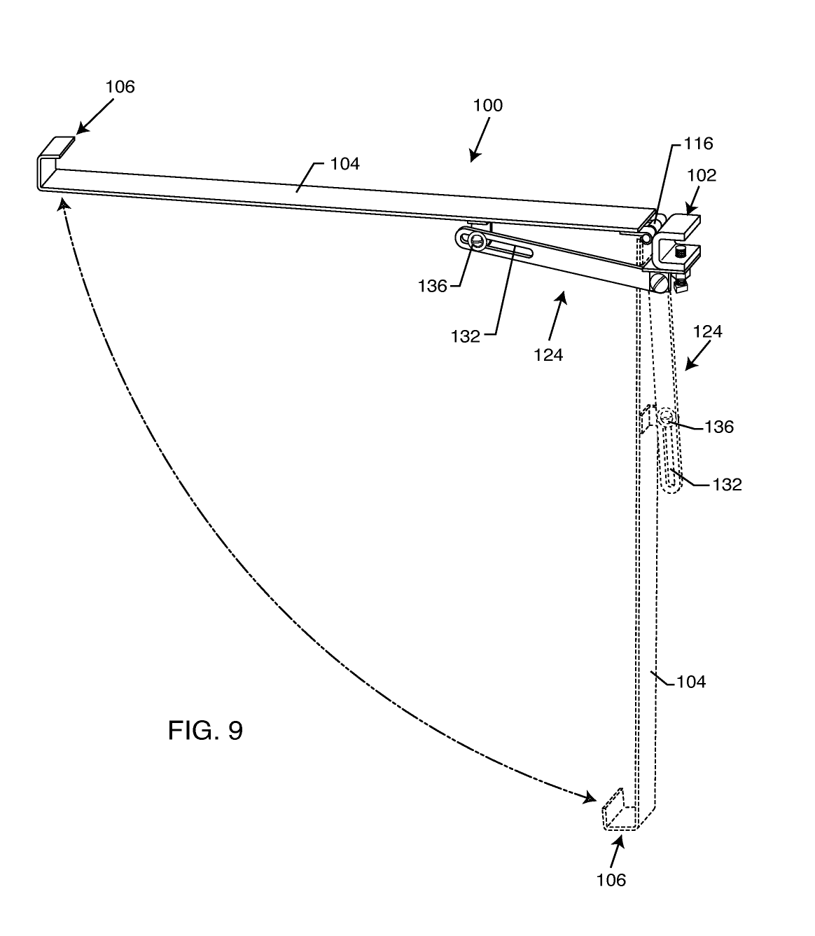

With reference now to FIGS. 5-9, one end of the arm 104 is pivotally attached to the clamp 102. Typically, this is accomplished by means of a hinge 116 which interconnects a portion of the clamp 102 with an end of the arm 104, as illustrated. This enables the arm to be moved from a generally at rest vertical position, as illustrated in FIG. 5, to a generally horizontal position, as illustrated in FIGS. 8 and 9.

With reference again to FIG. 5, the catch 106 is comprised of a portion of the arm 104, a platform 118 extending generally transverse to the longitudinal axis of the arm 104, and a projection 120 which extends from the platform 118, in spaced relation to the arm 104 and generally parallel thereto. Thus, the arm 104, the platform 118, the projection 120 form a generally open-faced channel 122, or a hook-shaped catch member 106, which is adapted and configured to removably receive an edge 12 of a sheet of material 10 to be cut therein.

With reference again to FIGS. 1-4, the platform 118 is adapted to receive and hold the edge 12 of the sheet of material 10 thereon when the device 100 is in its at rest vertical position, as illustrated in FIG. 1. It will be appreciated by those skilled in the art that the width of the sheet of material 10 can vary from a fraction of an inch to more than an inch in width, and thus the width of the platform 118, or the distance between the projection 120 and the arm 104 should be sufficient to accommodate this. However, this distance is typically not more than a few inches.

Once the sheet of material 10 has been positioned on the device 100, as illustrated in FIG. 1, the individual grasps the sheet of material 10 and rotates it to a generally horizontal position, as illustrated in FIG. 2, wherein typically at least a portion of the sheet of material 10 will rest upon the table 22 of the table saw 20. As can be seen in FIG. 2, the arm 104 of the device 100 is also moved into the horizontal position by virtue of the fact that the edge 12 of the sheet of material resides within the catch 106 of the device 100. It will be appreciated by those skilled in the art that the positioning and placement of a large and unwieldy sheet of material 10, which oftentimes can be several feet in diameter and length can be difficult. It is much easier to place an edge of the sheet 10 on the catch 106 of the device 100, and then rotate the sheet 10 onto the table 22 of the table saw 20, rather than trying to lift and position the sheet of material 10 onto the table saw 20 without the device.

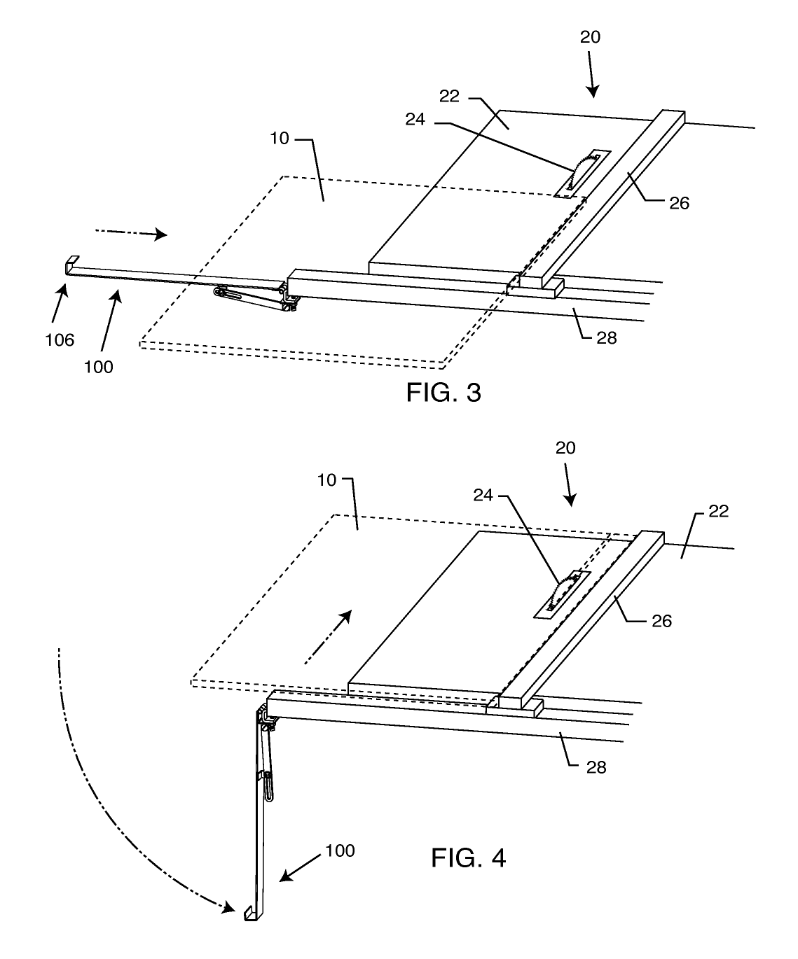

With reference now to FIGS. 3 and 4, once the sheet of material 10 is moved into the generally horizontal position, it is slid onto the table 22, releasing it from the catch 106, whereupon the arm 104 of the device 100 swings downwardly back into an at rest vertical position, as illustrated in FIG. 4. The sheet of material 10 can then be cut by the blade 24 of the table saw 20, as illustrated in FIG. 4.

When the table saw 20 includes a fence, the sheet of material 10 will typically be brought into engagement with the fence guide 26. Typically, the front fence rail 28 is disposed slightly below the top surface of the table 22, as illustrated. Generally, this is not a problem as the sheet of material will have at least a portion thereof placed onto the table 22 surface. However, in some cases, it may be desirable to have a riser block (not shown) attached to an upper surface of the fence rail 28 such that the sheet of material 10 can rest both upon the riser block, as well as the table 22.

With reference again to FIGS. 5, 8 and 9, in a particularly preferred embodiment, the arm 104 is comprised of a generally flat bar, such as plate steel or the like. This provides the arm 104 with sufficient strength and rigidity, as well as providing a generally planar surface for the sheet of material to tend to rest thereagainst or thereon during use. Typically, the catch 106 is integrally formed at the end of the arm 104, such as by bending the arm 104 into the generally hooked configuration described above.

With reference to FIGS. 3 and 4, as indicated above, when the sheet 10 of material is slid out of the catch 106, the weight of the arm 104 causes the arm 104 to fall from a generally horizontal position to a generally vertical position. Given the pivotal connection between the arm 104 and the clamp 102, this can occur very rapidly, and in fact the arm 104, due to its momentum, can swing back and forth. As the individual handling the sheet of material 10 might be in sufficiently close proximity to be hit by the swinging arm 104, or the arm 104 could swing into contact with another object, such as another portion of the table saw 20, the present invention preferably incorporates a damper device 124.

The damper device 124, as illustrated in FIGS. 5 and 8 is interconnected between the clamp 102 and the arm 104. The damper device is adapted to dampen movement, and particularly downward movement, of the arm 104. The damper device 124 comprises a bar or rod 126 pivotally connected at one end thereof to the clamp 102. This may be done by virtue of a bolt or pin 128 extending through the end of the bar 126 and either directly into the U-shaped member 108 of the clamp 102, or more typically into a bracket 130 interconnecting the clamp 102 and the bar 126. In the case where the clamp 102 is attached to the fence, as illustrated in FIGS. 6 and 7, the bracket 130 has a generally angular configuration, typically ninety degrees between ends of the bracket interconnecting the clamp 102 to the end of the bar 126.

An elongated slot 132 is formed in the bar 126. A resistive member 134 extends from the arm 104 and into the slot 132. More particularly, the resistive member comprises a bolt or pin 136 which extends through the slot 132 and has at least one washer 138 in frictional engagement with the bar 126. The pin extends through a bracket 140 interconnecting the pin or bolt 136 to the arm 104. A fastener, such as a nut or the like, secures the bolt or pin 136 in place. Typically, the bolt or pin 136 has a washer 138 disposed between a head thereof and the bar 126, and a washer on an opposite side of the bar 126 between the bar 126 and the fastener so as to be in frictional engagement with the bar. The fastener may be adjustable to increase or decrease the frictional engagement of the washer with the bar 126.

With reference now to FIG. 9, one can see that the bolt or pin 136 is disposed at a first position in the slot 132 when the arm 104 is disposed in a generally vertical position, but that the bolt or pin 136 slidably moves within the slot 132 to a different position as the arm 104 is moved into a generally horizontal position. The frictional engagement between the at least one washer 138 and the bar 126 still allows the arm 104 to be moved, but impedes and dampens the movement somewhat, such that when the arm 104 is released from its generally horizontal position, the speed with which it drops is dampened so as to reduce or even eliminate the swinging effect that would otherwise occur.

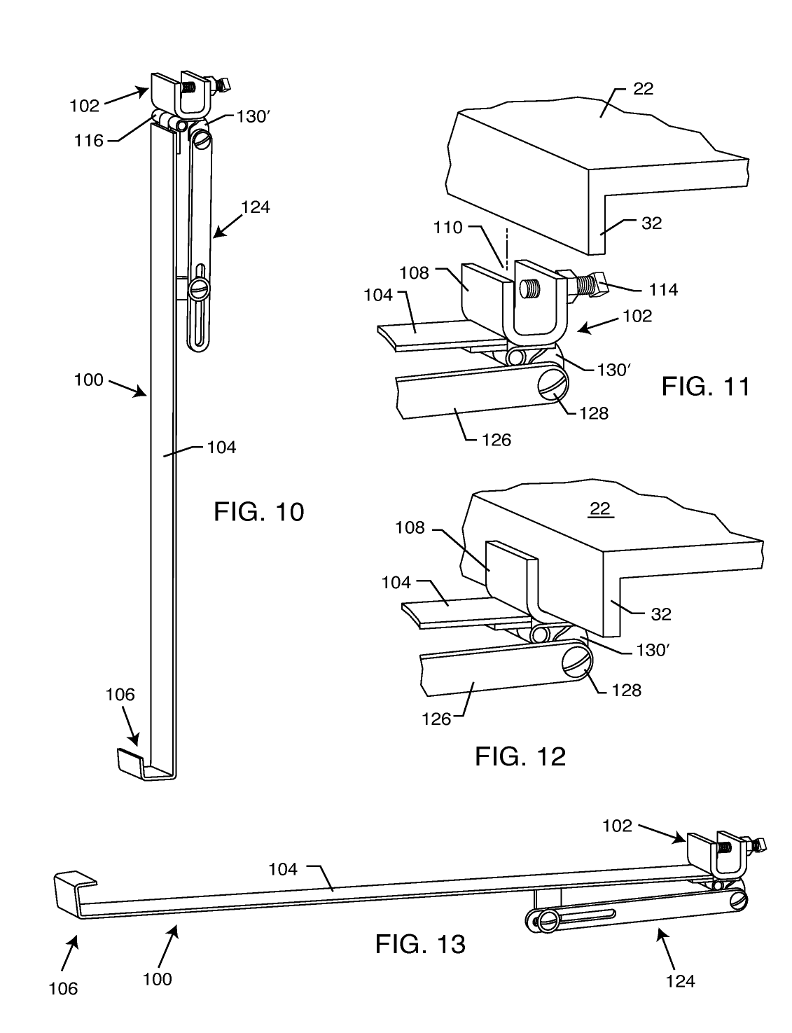

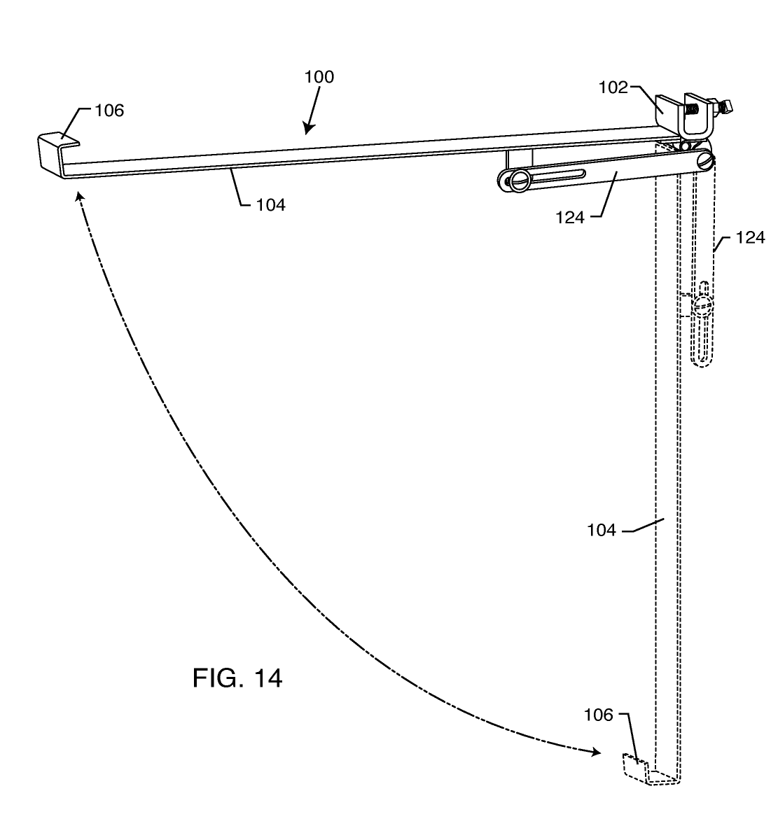

With reference now to FIGS. 10-14, the foregoing drawings and description related to the device 100 being connected to an end wall of the fence rail 28. It will be appreciated that in some cases the table saw 20 may not include a fence, or it will otherwise be desirable to attach the clamp 102 to an exposed side edge 32 of the table 22 of the table saw 20. Typically, such exposed edge 32 is directed generally downwardly as a lip, as illustrated in FIG. 11. The U-shaped member 108 of the clamp 102 is oriented such that the open-faced channel 110 thereof faces generally upwardly so as to receive the downwardly directed lip edge 32 therein. The set screw or bolt 114 is then tightened, as described above, so as to secure the clamp 102 to the edge of the table 22 of the table saw 20. It has been found that due to this orientation, the bracket 130′, instead of forming a generally ninety degree elbow, must be twisted for the damper device 124 to function properly. Otherwise, the remaining components are of the same configuration and function, as described above.

Although several embodiments have been described in detail for purposes of illustration, various modifications may be made without departing from the scope and spirit of the invention. Accordingly, the invention is not to be limited, except as by the appended claims.

What is claimed is:

1. A sheet positioning device for a table saw, comprising:
a clamp attachable to the table saw;
an arm pivotally attached to the clamp; and
a platform extending from the arm generally transverse to a longitudinal axis of the arm, the platform configured to receive an edge of the sheet thereon;
whereby an edge of the sheet is disposed on the platform, and the arm is pivoted upwardly until the sheet is moved onto a top table surface of the table saw.

2. The device of claim 1, wherein the clamp comprises a generally U-shaped member having a bolt extendable therein.

3. The device of claim 2, wherein the clamp is adapted to be inserted over and affixed to an edge of the table of the table saw.

4. The device of claim 2, wherein the clamp is adapted to be inserted over and affixed to a wall of a fence of the table saw.

5. The device of claim 1, including an projection extending away from the platform and generally parallel to the arm, such that the arm, platform and projection create an open-faced catch.

6. The device of claim 1, wherein the platform extends outwardly from the arm at an end thereof generally opposite the clamp.

7. The device of claim 1, including a damper device interconnected between the arm and the clamp and adapted to dampen downward movement of the arm.

8. The device of claim 7, wherein the damper device comprises a bar pivotally attached to the clamp and including an elongated slot therein, and a resistive member extending from the arm and into the slot.

9. The device of claim 8, wherein the resistive member comprises a bolt extending through the slot and having at least one washer in frictional engagement with the bar.

10. A sheet positioning device for a table saw, comprising:
a clamp attachable to an edge of a table or a wall of a fence of the table saw;
an arm pivotally attached to the clamp at one end thereof; and
a catch extending from a generally opposite end of the arm configured to receive an edge of the sheet therein;
whereby an edge of the sheet is disposed in the catch, and the arm is pivoted upwardly by rotating the sheet until the sheet is moved from a generally vertical orientation to a generally horizontal orientation and onto a top table surface of the table saw.

11. The device of claim 10, wherein the clamp comprises a generally U-shaped member having a bolt extendable therein.

12. The device of claim 10, wherein the catch comprises a platform extending from the arm generally transverse to a longitudinal axis of the arm and a projection extending from the platform in spaced relation and generally parallel to the arm.

13. The device of claim 10, including a damper device interconnected between the arm and the clamp and adapted to dampen downward movement of the arm.

14. The device of claim 13, wherein the damper device comprises a bar pivotally attached to the clamp and including an elongated slot therein, and a resistive member extending from the arm and into the slot.

15. The device of claim 14, wherein the resistive member comprises a bolt extending through the slot and having at least one washer in frictional engagement with the bar.

16. A sheet positioning device for a table saw, comprising:
a clamp attachable to an edge of a table or a wall of a fence of the table saw;
an arm pivotally attached to the clamp at one end thereof;
a catch extending from a generally opposite end of the arm and comprising a platform extending from the arm generally transverse to a longitudinal axis of the arm, and a projection extending from the platform in spaced relation and generally parallel to the arm; and
a damper device interconnected between the arm and the clamp and adapted to dampen downward movement of the arm;
whereby an edge of the sheet is disposed in the catch, and the arm is pivoted upwardly by rotating the sheet until the sheet is moved from a generally vertical orientation to a generally horizontal orientation and onto a top table surface of the table saw.

17. The device of claim 16, wherein the clamp comprises a generally U-shaped member having a bolt extendable therein.

18. The device of claim 16, wherein the damper device comprises a bar pivotally attached to the clamp and including an elongated slot therein, and a resistive member extending from the arm and into the slot.

19. The device of claim 18, wherein the resistive member comprises a bolt extending through the slot and having at least one washer in frictional engagement with the bar.
